(19) United States
(12) Patent Application Publication
(10) Pub. No.: US 2024/0053468 A1
(43) Pub. Date: Feb. 15, 2024

(54) VEHICLE-MOUNTED BSD MILLIMETER WAVE RADAR BASED METHOD FOR OBSTACLE RECOGNITION AT LOW SPEED

(71) Applicant: NANJING DESAY SV AUTOMOTIVE CO., LTD., Jiangning District, Nanjing, Jiangsu (CN)

(72) Inventors: Qiongfeng ZHOU, Jiangning District, Nanjing, Jiangsu (CN); Jiahuan LIU, Jiangning District, Nanjing, Jiangsu (CN)

(21) Appl. No.: 18/269,296

(22) PCT Filed: Jun. 25, 2021
(86) PCT No.: PCT/CN2021/102232

§ 371 Date: Jun. 23, 2023

(30) Foreign Application Priority Data
Dec. 25, 2020 (CN) 202011568157.6

(51) Int. Cl. G01S 13/931; G01S 7/41

(52) U.S. Cl. CPC G01S 13/931; G01S 7/415

(57) ABSTRACT

Disclosed is a vehicle-mounded BSD millimeter wave radar based method for obstacle recognition at a low speed. The method includes: detecting, by a vehicle-mounted BSD millimeter wave radar, surrounding targets in real time, collecting target detection point information of a current frame, and processing the target detection point information to obtain a list of target information, performing moving/static state recognition on target detection points in the list of target information, and collecting target detection point information of a plurality of frames in a static state to obtain a list of static targets; clustering target detection points in the list of static targets to obtain recognized obstacle information; and calculating a collision risk between a vehicle and an obstacle based on the obstacle information. The obstacle recognition method is simple and easy to operate, can quickly and accurately determine the moving/static state of a target, is high in applicability and recognition rate, increases the application scenarios of a BSD radar, reduces the collision risk of a blind area of a vehicle, and improves the driving safety of a vehicle.

### BACKGROUND OF THE INVENTION

The present disclosure relates to the technical field of obstacle recognition for vehicles, in particular to a vehicle-mounted BSD millimeter wave radar based method for obstacle recognition at a low speed.

At present, a vehicle-mounted BSD millimeter wave radar is mainly used to detect targets in a blind area beside or behind a vehicle and gives a warning during normal driving, to avoid collisions with a vehicle behind when a vehicle changes lanes. However, the radar does not play its detection role when the vehicle is driving at a low speed.

When the vehicle is driving at a low speed, the surrounding environment is generally relatively complex, and there are usually more obstacles around the vehicle. It is difficult for drivers with average driving level to drive through, and collisions with obstacles are easily caused. Meanwhile, the BSD radar has larger measurement errors in the aspects of detection point angle and speed in the blind area than other positions, and it is difficult to determine a moving/static state of the target. Moreover, the vehicle-mounted BSD millimeter wave radar has different recognition efficiencies for static obstacles made of different materials. Some targets have few reflection points and unstable positions, which may be missed during recognition. Therefore, if the vehicle-mounted BSD millimeter wave radar may help recognize obstacles when the vehicle is driving at a low speed, the radar may assist in safety passage of drivers, and meanwhile, the usage efficiency of the radar is improved.

### BRIEF SUMMARY OF THE INVENTION

In order to solve the problem of inaccurate recognition of obstacles in a blind area by a vehicle-mounted BSD millimeter wave radar under the condition of low speed driving of a vehicle in the prior art, the present disclosure provides a vehicle-mounted BSD millimeter wave radar based method for obstacle recognition at a low speed.

In order to solve the above-mentioned technical problem, the present disclosure adopts the following technical solutions.

A vehicle-mounted BSD millimeter wave radar based method for obstacle recognition at a low speed includes:
detecting, by a vehicle-mounted BSD millimeter wave radar, surrounding targets in real time, collecting target detection point information of a current frame, and processing the target detection point information to obtain a list of target information;
performing moving/static state recognition on target detection points in the list of target information, and collecting target detection point information of a plurality of frames in a static state to obtain a list of static targets;
clustering target detection points in the list of static targets to obtain recognized obstacle information; and
calculating a collision risk between a vehicle and an obstacle based on the obstacle information.

Further, as preferred technical solutions, the performing moving/static state recognition on target detection points in the list of target information specifically includes:
calculating an absolute value of a ground radial speed of a target based on a motion speed of the vehicle and the target detection point information;
performing interval division on a moving/static state determination threshold based on the moving/static state determination threshold;
comparing the absolute value of the ground radial speed of the target with the moving/static state determination threshold to determine an interval where the absolute value of the ground radial speed of the target is located; and
determining a state of the target based on the interval where the absolute value of the ground radial speed of the target is located, a vehicle state, and target distance information.

Further, as preferred technical solutions, the target detection point information includes position information of the target, radial motion speed information of the target relative to the vehicle, and azimuth angle information of the target relative to the vehicle; and
calculation of the absolute value of the ground radial speed of the target specifically includes: the sum of the radial motion speed of the target relative to the vehicle and a product of the speed and the cosine of the azimuth angle of the target relative to the vehicle.

Further, as preferred technical solutions, the determined intervals include a first threshold interval, a second threshold interval, a third threshold interval, and a fourth threshold interval;
the first threshold interval, the second threshold interval, the third threshold interval, and the fourth threshold interval are set based on statistics of a large number of real vehicle test data;
the first threshold interval is smaller than or equal to 0.1 m/s;
the second threshold interval is greater than 0.1 m/s and smaller than or equal to 0.25 m/s;
the third threshold interval is greater than 0.25 m/s and smaller than or equal to 0.4 m/s; and
the fourth threshold interval is greater than 0.4 m/s and smaller than or equal to 0.6 m/s.

Further, as preferred technical solutions, the determining a state of the target based on the interval where the absolute value of the ground radial speed of the target is located, a vehicle state, and target distance information specifically includes:
when the absolute value of the ground radial speed of the target is within the first threshold interval, determining the target as a static target;
when the absolute value of the ground radial speed of the target is within the second threshold interval, determining a motion state of the vehicle; if the vehicle is in a static state, a left-right distance between the target and the vehicle is within a range of a first threshold, and a front-back distance between the target and the vehicle is within a range of a second threshold, determining the target as a static target; and if the vehicle is in a moving state, determining the target as a static target;
when the absolute value of the ground radial speed of the target is within the third threshold interval, determining the motion state of the vehicle; if the vehicle is in the static state, the left-right distance between the target and the vehicle is within the range of the first threshold, and the front-back distance between the target and the vehicle is within the range of the second threshold, determining the target as a static target; if the vehicle is in a straight driving state, the left-right distance between the target and the vehicle is within the range of the first threshold or the front-back distance between the target and the vehicle is within a range of a third threshold, determining the target as a static target; and if the vehicle is in a turning state, determining the target as a static target; and
when the absolute value of the ground radial speed of the target is within the fourth threshold interval, determining the motion state of the vehicle; if the vehicle is in the static state, the left-right distance between the target and the vehicle is within the range of the first threshold, and the front-back distance between the target and the vehicle is within the range of the second threshold, determining the target as a static target; if the vehicle is in the straight driving state and the front-back distance between the target and the vehicle is within the range of the third threshold, determining the target as a static target; and if the vehicle is in the turning state and the front-back distance between the target and the vehicle is within a range of a fourth threshold, determining the target as a static target.

Further, as preferred technical solutions, determination of the straight driving state and the turning state of the vehicle includes:
comparing an absolute value of a yaw rate of the vehicle with a fifth threshold; when the absolute value of the yaw rate of the vehicle is smaller than or equal to the fifth threshold, determining that the vehicle is in the straight driving state; otherwise, determining that the vehicle is in the turning state.

Further, as preferred technical solutions, the first threshold, the second threshold, the third threshold, the fourth threshold, and the fifth threshold are set based on statistics of a large number of real vehicle test data;
the first threshold ranges from 0.8 m to 1.2 m;
the second threshold ranges from 2.5 m to 3.5 m;
the third threshold ranges from 4.5 m to 5.5 m;
the fourth threshold ranges from 25 m to 35 m; and
the fifth threshold ranges from 4°/s to 6°/s.

Further, as preferred technical solutions, the clustering target detection points in the list of static targets specifically includes:
performing difference operation on position information of two adjacent targets in the list of static targets, determining the two adjacent targets as the same target when absolute values of position differences between the two adjacent targets are within a range of a sixth threshold, otherwise, determining the two adjacent targets as two targets; and
obtaining a list of clustered targets after traversing the list of static targets, thereby obtaining the recognized obstacle information.

Further, as preferred technical solutions, the recognized obstacle information includes the quantity of the targets, a position distribution range of the targets, a position of a clustered center target, and an average speed of the targets relative to the vehicle.

Further, as preferred technical solutions, the calculating a collision risk between a vehicle and an obstacle includes: calculating time to collision between the vehicle and the target based on the position of the target and the average speed of the target relative to the vehicle, thereby obtaining the collision risk between the vehicle and the obstacle.

Compared with the prior art, the technical solutions of the present disclosure have the following beneficial effects:
the obstacle recognition method according to the present disclosure is simple and easy to operate, can quickly and accurately determine the moving/static state of a target, is high in applicability and recognition rate, increases the application scenarios of the BSD radar, reduces the collision risk of the blind area of a vehicle, and improves the driving safety of a vehicle.

### BRIEF DESCRIPTION OF THE DRAWINGS

FIG. 1 is a flow diagram according to the present disclosure.

FIG. 2 is a distribution diagram of obstacles around a vehicle according to the present disclosure.

The accompanying drawings are for illustrative purposes only and are not to be construed as limiting the patent. In order to better illustrate the embodiments, some parts of the accompanying drawings may be omitted, enlarged or reduced and do not represent actual product dimensions. It may be appreciated by those skilled in the art that some well-known structures and their descriptions may be omitted from the accompanying drawings. The same or similar reference numerals correspond to the same or similar parts. The terms used in the accompanying drawings to describe positional relationships are for illustrative purposes only and are not to be construed as limiting the patent.

### DETAILED DESCRIPTION OF THE INVENTION

The preferred embodiments of the present disclosure are described in detail below in conjunction with the accompanying drawings, so that the advantages and features of the present disclosure may be more easily understood by those skilled in the art and thus provide a clearer definition of the scope of protection of the present disclosure.

The same or similar reference numerals in the accompanying drawings of the embodiments of the present disclosure correspond to the same or similar components. In the description of the present disclosure, it should be understood that the terms “upper”, “lower”, “left”, “right”, “top”, “bottom”, “inside”, “outside”, etc. indicate orientations or positional relationships based on the orientations or positional relationships shown in the accompanying drawings, and are merely for the convenience of describing the present disclosure and simplifying the description, rather than indicating or implying that the referred devices or components must have a specific orientation, be constructed and operated in a specific orientation, so the terms describing the positional relationship in the accompanying drawings are for illustrative purposes merely and should not be construed as limitations on the patent.

In addition, terms “first”, “second”, etc. are used for descriptive purposes merely, primarily to distinguish between different devices, components or parts (specific types and configurations may be the same or different), not to indicate or imply relative importance and number of the referred devices, components or parts, and thus they should not be construed as indicating or implying relative importance.

### Embodiment 1

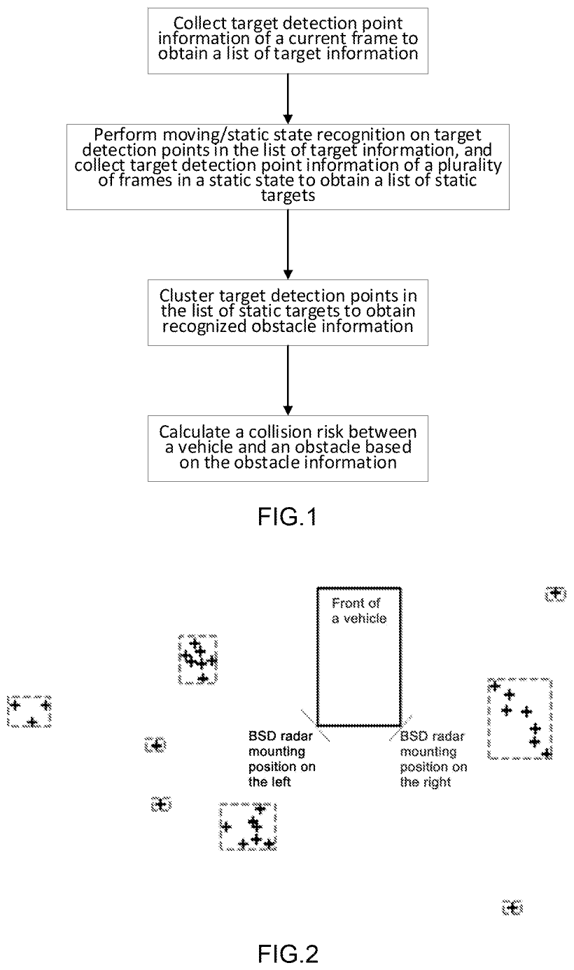

This embodiment discloses a vehicle-mounted BSD millimeter wave radar based method for obstacle recognition at a low speed. As shown in FIG. 1, the method includes:
in step S1, surrounding targets are detected by a vehicle-mounted BSD millimeter wave radar in real time, target detection point information of a current frame is collected, and the target detection point information is processed to obtain a list of target information.

This step specifically includes:
the vehicle-mounted BSD millimeter wave radar detects the surrounding targets in real time, detected data information is subjected to signal processing to obtain the target detection point information of the current frame, and target detection point information of a plurality of frames is collected to obtain the list of target information.

In this embodiment, the target detection point information includes position information of a target, radial motion speed information of the target relative to a vehicle, and azimuth angle information of the target relative to the vehicle.

The list of target information includes the position information of the target, the radial motion speed information of the target relative to the vehicle, and the azimuth angle information of the target relative to the vehicle.

In step S2, moving/static state recognition is performed on target detection points in the list of target information, and target detection point information of a plurality of frames in a static state is collected to obtain a list of static targets.

In this step, the performing moving/static state recognition on target detection points in the list of target information specifically includes:

In step S21, an absolute value of a ground radial speed of the target is calculated based on a motion speed of the vehicle and the target detection point information.

In this step, calculation of the absolute value of the ground radial speed of the target specifically includes: the sum of the radial motion speed of the target relative to the vehicle and a product of the speed and the cosine of the azimuth angle of the target relative to the vehicle.

The absolute value of the ground radial speed of the target is calculated according to the following formula:

abSpeed=rSpeed+Speed*cos(angle)

where abSpeed denotes the absolute value of the ground radial speed of the target, rSpeed denotes the radial motion speed of the target relative to the vehicle, Speed denotes the speed of the vehicle, and angle denotes the azimuth angle of the target relative to the vehicle.

In step S22, interval division is performed on a moving/static state determination threshold based on the moving/static state determination threshold.

In this step, the determined intervals for the moving/static state determination threshold include a first threshold interval, a second threshold interval, a third threshold interval, and a fourth threshold interval.

The first threshold interval, the second threshold interval, the third threshold interval and the fourth threshold interval are set based on statistics of a large number of real vehicle test data.

In this embodiment, the first threshold interval is smaller than or equal to 0.1 m/s;
the second threshold interval is greater than 0.1 m/s and smaller than or equal to 0.25 m/s;
the third threshold interval is greater than 0.25 m/s and smaller than or equal to 0.4 m/s; and
the fourth threshold interval is greater than 0.4 m/s and smaller than or equal to 0.6 m/s.

In step S23, the absolute value of the ground radial speed of the target is compared with the moving/static state determination threshold to determine an interval where the absolute value of the ground radial speed of the target is located.

In step S24, a state of the target is determined based on the interval where the absolute value of the ground radial speed of the target is located, a vehicle state, and target distance information.

This step specifically includes:
when the absolute value of the ground radial speed of the target is within the first threshold interval, the target is determined as a static target.

When the absolute value of the ground radial speed of the target is within the second threshold interval, a motion state of the vehicle is further determined. If the vehicle is in a static state, a left-right distance between the target and the vehicle is within a range of a first threshold, and a front-back distance between the target and the vehicle is within a range of a second threshold, the target is determined as a static target. If the vehicle is in a moving state, the target is determined as a static target.

When the absolute value of the ground radial speed of the target is within the third threshold interval, if the vehicle is in the static state, the left-right distance between the target and the vehicle is within the range of the first threshold, and the front-back distance between the target and the vehicle is within the range of the second threshold, the target is determined as a static target. If the vehicle is in a straight driving state, the left-right distance between the target and the vehicle is within the range of the first threshold or the front-back distance between the target and the vehicle is within a range of a third threshold, the target is determined as a static target. If the vehicle is in a turning state, the target is determined as a static target.

When the absolute value of the ground radial speed of the target is within the fourth threshold interval, if the vehicle is in the static state, the left-right distance between the target and the vehicle is within the range of the first threshold, and the front-back distance between the target and the vehicle is within the range of the second threshold, the target is determined as a static target. If the vehicle is in the straight driving state and the front-back distance between the target and the vehicle is within the range of the third threshold, the target is determined as a static target. If the vehicle is in the turning state and the front-back distance between the target and the vehicle is within a range of a fourth threshold, the target is determined as a static target.

In this step, the left-right distance between the target and the vehicle specifically refers to a left-right distance between the target and a BSD radar mounting position of the vehicle, and the front-back distance between the target and the vehicle specifically refers to a front-back distance between the target and the BSD radar mounting position of the vehicle.

Determination of the straight driving state and the turning state of the vehicle includes:
an absolute value of a yaw rate of the vehicle is compared with a fifth threshold; when the absolute value of the yaw rate of the vehicle is smaller than or equal to the fifth threshold, it is determined that the vehicle is in the straight driving state; otherwise, it is determined that the vehicle is in the turning state.

In this step, the first threshold, the second threshold, the third threshold, the fourth threshold, and the fifth threshold are set based on statistics of a large number of real vehicle test data.

The first threshold ranges from 0.8 m to 1.2 m;
the second threshold ranges from 2.5 m to 3.5 m;
the third threshold ranges from 4.5 m to 5.5 m;
the fourth threshold ranges from 25 m to 35 m; and
the fifth threshold ranges from 4°/s to 6°/s.

Preferably, the first threshold is set as 1.0 m;
the second threshold is set as 3 m;
the third threshold is set as 5 m;
the fourth threshold is set as 30 m; and
the fifth threshold is set as 5°/s.

In another embodiment, this step may also be expressed as follows:
when the absolute value of abSpeed is smaller than or equal to 0.1 m/s, the target is determined as a static target.

When the absolute value of abSpeed is greater than 0.1 m/s and smaller than or equal to 0.25 m/s, the motion state of the vehicle is determined. If the vehicle is in the static state, the left-right distance between the target and the BSD radar mounting position of the vehicle is within 1 m, and the front-back distance between the target and the BSD radar mounting position of the vehicle is within 3 m, the target is determined as a static target. If the vehicle is in the moving state, the target is determined as a static target.

When the absolute value of abSpeed is greater than 0.25 m/s and smaller than or equal to 0.4 m/s, the motion state of the vehicle is determined. If the vehicle is in the static state, the left-right distance between the target and the BSD radar mounting position of the vehicle is within 1 m, and the front-back distance between the target and the BSD radar mounting position of the vehicle is within 3 m, the target is determined as a static target. If the vehicle is in the moving state, whether the vehicle is in the straight driving state or the turning state is determined based on the absolute value of the yaw rate of the vehicle. If the vehicle is in the straight driving state, and the left-right distance between the target and the BSD radar mounting position of the vehicle is within 1 m or the front-back distance between the target and the BSD radar mounting position of the vehicle is within 5 m, the target is determined as a static target. If the vehicle is in the turning state, the target is determined as a static target.

When the absolute value of abSpeed is greater than 0.4 m/s and smaller than or equal to 0.6 m/s, the motion state of the vehicle is determined. If the vehicle is in the static state, the left-right distance between the target and the BSD radar mounting position of the vehicle is within 1 m, and the front-back distance between the target and the BSD radar mounting position of the vehicle is within 3 m, the target is determined as a static target. If the vehicle is in the moving state, whether the vehicle is in the straight driving state or the turning state is determined based on the absolute value of the yaw rate of the vehicle. If the vehicle is in the straight driving state, and the front-back distance between the target and the BSD radar mounting position of the vehicle is within 5 m, the target is determined as a static target. If the vehicle is in the turning state, and the front-back distance between the target and the BSD radar mounting position of the vehicle is within 30 m, the target is determined as a static target.

The straight driving state and the turning state of the vehicle may also be expressed as follows:
the absolute value of the yaw rate of the vehicle is compared with the fifth threshold; when the absolute value of the yaw rate of the vehicle is smaller than or equal to the fifth threshold, it is determined that the vehicle is in the straight driving state; otherwise, it is determined that the vehicle is in the turning state.

When the absolute value of YawRate is smaller than or equal to 5°/s, it is determined that the vehicle is in the straight driving state; otherwise, it is determined that the vehicle is in the turning state.

In step S3, target detection points in the list of static targets are clustered to obtain recognized obstacle information.

This step specifically includes:
difference operation is performed on position information of two adjacent targets in the list of static targets; the two adjacent targets are determined as the same target when absolute values of position differences between the two adjacent targets are within a range of a sixth threshold; otherwise, the two adjacent targets are determined as two targets.

Specific calculation in this step includes:
coordinate information of the target, that is, the projection x, y of the target in the coordinate system of the vehicle, is calculated based on the list of target information.

The coordinate information is obtained by converting the position information of the target in the target list and the azimuth angle information of the target relative to the vehicle.

Specifically, x=r*sin(angle), and y=r*cos(angle),
where r denotes the position information of the target, that is, the distance between the target and the BSD radar mounting position of the vehicle, and angle denotes the azimuth angle of the target relative to the vehicle.

The absolute values of the differences between the coordinates of two adjacent objects are obtained.

Specifically, deltX=|x_a−x_b|, and deltY=|y_a−y_b|,
where x_a and x_b denote horizontal coordinates of the two adjacent targets a and b, y_a and y_b denote vertical coordinates of the two adjacent targets a and b, and deltX and deltY denote the absolute value of the difference between the horizontal coordinates and the absolute value of the difference between the vertical coordinates of the two adjacent targets a and b.

The absolute value of the difference between the horizontal coordinates and the absolute value of the difference between the vertical coordinates of the two adjacent targets a and b are compared with the sixth threshold. When the absolute value of the difference between the horizontal coordinates and the absolute value of the difference between the vertical coordinates of the two adjacent targets a and b are both smaller than or equal to the sixth threshold, the two adjacent targets are determined as the same target.

In this step, the sixth threshold ranges from 0.8 m to 1.2 m. Preferably, the sixth threshold is set to 1 m.

By adoption of the above method, all the targets in the list of static targets are recognized to complete the clustering of the list of static targets, so as to obtain the recognized obstacle information, which is the process of obstacle recognition.

In this step, the recognized obstacle information includes the quantity of the clustered targets, a position distribution range of the targets, a position of a clustered center target, and an average speed of the targets relative to the vehicle.

As shown in FIG. 2, BSD radars are mounted on a left side and a right side of the rear of the vehicle respectively to detect surrounding obstacles, then target points indicated by the black+sign are obtained, the dashed box indicates a result of clustering, that is, target points in the dashed box belong to the same target, that is, the same obstacle, and the length and width of the dashed box are the size after obstacle recognition.

In step S4, a collision risk between the vehicle and the obstacle is calculated based on the obstacle information.

This step includes:
based on the average speed of the obstacle relative to the vehicle and the position of the obstacle, the time to collision between the vehicle and the obstacle, i.e. the collision risk, is calculated by the following formula:

TTC=average(r)/average(rSpeed)
where TTC denotes time to collision, average(r) denotes an average value of target point measurement distances of obstacle recognition, and average(rSpeed) denotes the average speed of point measurement, that is, the average speed of the targets relative to the vehicle.

Apparently, the above embodiments of the present disclosure are merely examples of the present disclosure for purposes of clarity and are not intended to limit the implementations of the present disclosure. Changes or modifications in other different forms may also be made by a person of ordinary skill in the art on the basis of the above description. All implementations need not to be, and cannot be, exhaustive. Any modifications, equivalent replacements, improvements, etc. made within the spirit and principle of the present disclosure shall fall within the scope of protection of the claims of the present disclosure.

What is claimed is:

1. A vehicle-mounted BSD millimeter wave radar based method for obstacle recognition at a low speed, comprising:
detecting, by a vehicle-mounted BSD millimeter wave radar, surrounding targets in real time, collecting target detection point information of a current frame, and processing the target detection point information to obtain a list of target information;
performing moving/static state recognition on target detection points in the list of target information, and collecting target detection point information of a plurality of frames in a static state to obtain a list of static targets;
clustering target detection points in the list of static targets to obtain recognized obstacle information; and
calculating a collision risk between a vehicle and an obstacle based on the obstacle information.

2. The vehicle-mounted BSD millimeter wave radar based method for obstacle recognition at a low speed according to claim 1, wherein the performing moving/static state recognition on target detection points in the list of target information specifically comprises:
calculating an absolute value of a ground radial speed of a target based on a motion speed of the vehicle and the target detection point information;
performing interval division on a moving/static state determination threshold based on the moving/static state determination threshold;
comparing the absolute value of the ground radial speed of the target with the moving/static state determination threshold to determine an interval where the absolute value of the ground radial speed of the target is located; and
determining a state of the target based on the interval where the absolute value of the ground radial speed of the target is located, a vehicle state, and target distance information.

3. The vehicle-mounted BSD millimeter wave radar based method for obstacle recognition at a low speed according to claim 2, wherein the target detection point information comprises position information of the target, radial motion speed information of the target relative to the vehicle, and azimuth angle information of the target relative to the vehicle; and
calculation of the absolute value of the ground radial speed of the target specifically comprises: the sum of the radial motion speed of the target relative to the vehicle and a product of the speed and the cosine of the azimuth angle of the target relative to the vehicle.

4. The vehicle-mounted BSD millimeter wave radar based method for obstacle recognition at a low speed according to claim 2, wherein the determined intervals comprise a first threshold interval, a second threshold interval, a third threshold interval, and a fourth threshold interval;
the first threshold interval, the second threshold interval, the third threshold interval, and the fourth threshold interval are set based on statistics of a large number of real vehicle test data;
the first threshold interval is smaller than or equal to 0.1 m/s;
the second threshold interval is greater than 0.1 m/s and smaller than or equal to 0.25 m/s;
the third threshold interval is greater than 0.25 m/s and smaller than or equal to 0.4 m/s; and
the fourth threshold interval is greater than 0.4 m/s and smaller than or equal to 0.6 m/s.

5. The vehicle-mounted BSD millimeter wave radar based method for obstacle recognition at a low speed according to claim 4, wherein the determining a state of the target based on the interval where the absolute value of the ground radial speed of the target is located, a vehicle state, and target distance information specifically comprises:
when the absolute value of the ground radial speed of the target is within the first threshold interval, determining the target as a static target;
when the absolute value of the ground radial speed of the target is within the second threshold interval, determining a motion state of the vehicle; if the vehicle is in a static state, a left-right distance between the target and the vehicle is within a range of a first threshold, and a front-back distance between the target and the vehicle is within a range of a second threshold, determining the target as a static target; and if the vehicle is in a moving state, determining the target as a static target;
when the absolute value of the ground radial speed of the target is within the third threshold interval, determining the motion state of the vehicle; if the vehicle is in the static state, the left-right distance between the target and the vehicle is within the range of the first threshold, and the front-back distance between the target and the vehicle is within the range of the second threshold, determining the target as a static target; if the vehicle is in a straight driving state, the left-right distance between the target and the vehicle is within the range of the first threshold or the front-back distance between the target and the vehicle is within a range of a third threshold, determining the target as a static target; and if the vehicle is in a turning state, determining the target as a static target; and
when the absolute value of the ground radial speed of the target is within the fourth threshold interval, determining the motion state of the vehicle; if the vehicle is in the static state, the left-right distance between the target and the vehicle is within the range of the first threshold, and the front-back distance between the target and the vehicle is within the range of the second threshold, determining the target as a static target; if the vehicle is in the straight driving state and the front-back distance between the target and the vehicle is within the range of the third threshold, determining the target as a static target; and if the vehicle is in the turning state and the front-back distance between the target and the vehicle is within a range of a fourth threshold, determining the target as a static target.

6. The vehicle-mounted BSD millimeter wave radar based method for obstacle recognition at a low speed according to claim 5, wherein determination of the straight driving state and the turning state of the vehicle comprises:
comparing an absolute value of a yaw rate of the vehicle with a fifth threshold; when the absolute value of the yaw rate of the vehicle is smaller than or equal to the fifth threshold, determining that the vehicle is in the straight driving state; otherwise, determining that the vehicle is in the turning state.

7. The vehicle-mounted BSD millimeter wave radar based method for obstacle recognition at a low speed according to claim 6, wherein the first threshold, the second threshold, the third threshold, the fourth threshold, and the fifth threshold are set based on statistics of a large number of real vehicle test data;
the first threshold ranges from 0.8 m to 1.2 m;
the second threshold ranges from 2.5 m to 3.5 m;
the third threshold ranges from 4.5 m to 5.5 m;
the fourth threshold ranges from 25 m to 35 m; and
the fifth threshold ranges from 4°/s to 6°/s.

8. The vehicle-mounted BSD millimeter wave radar based method for obstacle recognition at a low speed according to claim 1, wherein the clustering target detection points in the list of static targets specifically comprises:
performing difference operation on position information of two adjacent targets in the list of static targets, determining the two adjacent targets as the same target when absolute values of position differences between the two adjacent targets are within a range of a sixth threshold, otherwise, determining the two adjacent targets as two targets; and
obtaining a list of clustered targets after traversing the list of static targets, thereby obtaining the recognized obstacle information.

9. The vehicle-mounted BSD millimeter wave radar based method for obstacle recognition at a low speed according to claim 8, wherein the recognized obstacle information comprises the quantity of the targets, a position distribution range of the targets, a position of a clustered center target, and an average speed of the targets relative to the vehicle.

10. The vehicle-mounted BSD millimeter wave radar based method for obstacle recognition at a low speed according to claim 9, wherein the calculating a collision risk between a vehicle and an obstacle comprises: calculating time to collision between the vehicle and the target based on the position of the target and the average speed of the targets relative to the vehicle, thereby obtaining the collision risk between the vehicle and the obstacle.
